(19) United States
(12) Patent Application Publication
(10) Pub. No.: US 2008/0107938 A1
(43) Pub. Date: May 8, 2008

(54) Reforming reaction unit for reformer comprising preheater and method of manufacturing the same

(76) Inventors: Chan-ho Lee, Suwon-si (KR); Ju-yong Kim, Suwon-si (KR); Jin-goo Ahn, Suwon-si (KR); Yong-kul Lee, Suwon-si (KR); Man-seok Han, Suwon-si (KR); Sung-chul Lee, Suwon-si (KR); Ho-jun Yoon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/890,023

(22) Filed: Aug. 3, 2007

(30) Foreign Application Priority Data
Nov. 2, 2006 (KR) 10-2006-0107863

(51) Int. Cl. H01M 8/18

(52) U.S. Cl. 429/20; 29/623.1; 429/19

(57) ABSTRACT

A reforming reaction unit for a reformer, and a method of manufacturing the same are disclosed. One embodiment of the reforming reaction unit includes: a cylindrical structure having a hollow space inside thereof; a cover surrounding the outer surface of the cylindrical structure; and a disc plate having a plurality of holes and directly contacting the inner surface of the cover at a predetermined position of the cylindrical structure in a lengthwise direction. The cylindrical structure includes an upper part above the disc plate. The upper part has a thread formed on its outer surface. The thread is in direct contact with the inner surface of the cover. The cylindrical structure also includes a lower part below the disc plate. The lower part has an outer surface spaced apart from the inner surface of the cover.

### CROSS-REFERENCE TO RELATED APPLICATIONS

This application claims the benefit of Korean Patent Application No. 2006-0107863, filed on Nov. 2, 2006, in the Korean Intellectual Property Office, the disclosure of which is incorporated herein by reference.

### BACKGROUND

1. Field

The present disclosure relates to a reforming reaction unit for a reformer including a preheater, and a method of manufacturing the same.

2. Description of the Related Technology

Generally, a fuel cell system is a power generator that produces electric energy, using a chemical reaction between hydrogen and oxygen. Fuel cell systems have been researched and developed as alternative power sources which can meet an increased demand of power and solve environmental problems. Hydrogen gas used for a fuel cell system can be extracted by reforming a hydrogen-containing fuel. The fuel may be an alcoholic fuel, such as methanol, ethanol, etc.; a hydro-carbon fuel such as methane, propane, butane, etc.; or a natural gas fuel such as liquefied natural gas, etc.

### SUMMARY

One embodiment provides a reforming reaction unit for a reformer integrally including a preheater to heat a hydrogen-containing fuel to be reformed and a method of manufacturing the same, thereby reforming the preheated hydrogen-containing fuel.

Another embodiment provides a reformer for use with a fuel cell, comprising: a first wall having an inner surface and an outer surface, the inner surface defining a heat pathway; a second wall substantially surrounding the outer surface of the first wall, the first and second walls having a space therebetween; and a partition interposed between the first and second walls, the partition dividing the space into a first space and a second space, the partition having at least one hole permitting fluid communication between the first and second spaces; and an inlet in fluid communication with the first space, wherein the first wall comprises a groove formed on the outer surface thereof in the first space, the groove and the second wall together defining a fluid pathway substantially surrounding the first wall, the fluid pathway leading from the inlet to the at least one hole of the partition.

The first space may serve as a preheater for a fuel. The second space may serve as a reforming reactor. The reformer may further comprise a reforming catalyst in the second space. The inlet may be formed through the second wall. The reformer may further comprise an outlet in fluid communication with the second space.

The reformer may further comprise a heat source positioned in the heat pathway. The heat source may comprise a burner or a combustion catalyst. The reformer may further comprise a discharging tube, the discharging tube comprising an internal tube and an external tube substantially surrounding the internal tube with a gap therebetween, the internal tube being in fluid communication with the heat pathway, the gap being in fluid communication with the first space through the inlet.

The first wall may comprise a cylindrical tube. The first wall may be formed of a substantially homogeneous material. The first wall may not be formed by combining two or more workpieces. The first wall may be formed by molding or machining.

The groove may form a spiral thread. The spiral thread may be formed by machining the outer surface of the first wall or by molding. The partition may be formed by machining the outer surface of the first wall or by molding.

Another embodiment provides a method of making the reformer described above. The method comprises: providing the first wall; providing the groove on the outer surface of the first wall; and providing the partition on the outer surface of the first wall; and providing the second wall so as to house the first wall.

Providing the first wall may comprise forming a cylindrical tube by machining or by molding. Providing the groove may comprise machining the outer surface of the first wall or molding. Providing the partition may comprise machining the outer surface of the first wall or molding.

Yet another embodiment provides a method of using the reformer described above. The method comprises: introducing a fuel through the inlet into the first space; flowing the fuel along the fluid pathway while providing heat along the heat pathway; flowing the fuel through the at least one hole into the second space; and subjecting the fuel to a reforming reaction in the second space.

Another embodiment provides a reforming reaction unit for a reformer, comprising: a cylindrical structure having a hollow space inside thereof; a cover surrounding an outer surface of the cylindrical structure; and a disc plate formed with a plurality of holes and directly contacting an inner surface of the cover at a predetermined position of the cylindrical structure in a lengthwise direction, wherein the cylindrical structure comprises an upper part that is placed above the disc plate and externally formed with a thread being in direct contact with the inner surface of the cover, and a lower part that is placed below the disc plate and has an outer surface to be spaced apart from the inner surface of the cover.

The disc plate and the cylindrical structure may be formed as a single body. A reforming catalyst may be filled between the outer surface of the lower part of the cylindrical structure and an inner surface of the cover. Between the cylindrical structure and the cover, a space formed by the thread may serve as a fuel channel through which a hydrogen-containing fuel flows. The cover may comprise a fuel inlet on a lateral side thereof, into which the hydrogen-containing fuel to be reformed is introduced, and the fuel inlet connects and communicates with the fuel channel. Under the lower part of the cylindrical structure is provided a reformed gas outlet through which reformed gas with abundant hydrogen is discharged.

The reforming reaction unit may further comprise a combustion unit placed in a bottom of the cylindrical structure within the hollow space. Further, the combustion unit comprises a burner or a combustion catalyst. The reforming reaction unit may further comprise a discharging tube to discharge exhaust gas produced by a combustion reaction of the combustion unit, and the discharging tube has a double-tube structure that comprises an internal tube having a relatively small diameter, and an external pip having a relatively large diameter. Further, the internal tube may serve as an exhaust gas channel through which the exhaust gas flows, and a space formed between the internal tube and the external tub serves as a refrigerant channel through which a refrigerant such as water flows. Also, the external tube may comprise a refrigerant inlet through which the refrigerant is introduced into the refrigerant channel, and a refrigerant outlet through which the refrigerant is discharged from the refrigerant channel. Here, the refrigerant outlet connects and communicates with the fuel inlet.

Another embodiment provides a method of manufacturing a reforming reaction unit for a reformer, the method comprising: preparing a cylindrical body; boring a hole through the cylindrical body in a lengthwise direction; cutting an outer surface of a lower part of the cylindrical body to have a predetermined diameter; and threading an outer surface of an upper part of the cylindrical body to have a thread.

The method may further comprise forming a disc plate by remaining an unprocessed part while the lower part of the cylindrical body is processed, and boring a plurality of holes through the disc plate.

### BRIEF DESCRIPTION OF THE DRAWINGS

These and/or other aspects of the instant disclosure will become apparent and more readily appreciated from the following description of certain embodiments, taken in conjunction with the accompanying drawings of which:

FIG. 1 is a schematic diagram of a fuel cell system with a reformer having a reforming reaction unit according to one embodiment;

FIG. 2 is an exploded cross-sectional view of a reforming reaction unit according to another embodiment;

FIG. 3 is an assembled cross-sectional view of the reforming reaction unit of FIG. 2;

FIG. 4 is a cross-sectional view of a reforming reaction unit according to another embodiment;

FIG. 5 is a dual exhaust valve according to one embodiment;

FIG. 6 is a cross-sectional view of the reforming reaction unit of FIG. 3 with a carbon monoxide (CO) remover coupled thereto;

FIGS. 7A-7D are perspective views illustrating a process of manufacturing a cylindrical structure for the reforming reaction unit according to one embodiment;

FIG. 8 is a cross-sectional view of an oxidation reformer;

FIG. 9 is a cross-sectional view of a hydrogen producer; and

FIG. 10 is a cross-sectional view of a fuel reforming apparatus.

### DETAILED DESCRIPTION

Hereinafter, exemplary embodiments will be described with reference to the accompanying drawings.

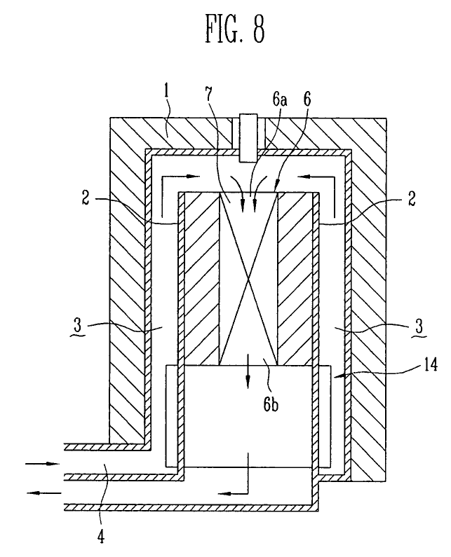

With respect to a reformer, Korean Patent Application Publication No. 2001-0102290 discloses a partial oxidation reformer (FIG. 8) with a double-wall structure. The reformer includes a housing 1 and inner partition-walls 2. A reforming reaction unit 6 is accommodated between the inner partition-walls 2. A space between the housing 1 and the partition wall 2 is used as a raw-gas passage 3. In this oxidation reformer, the reforming reaction unit 6 and the raw-gas passage 3 are disposed in parallel to each other.

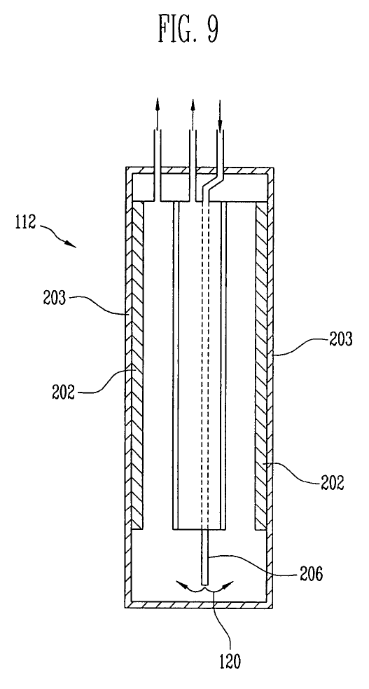

Further, Japanese Patent Application Publication No. 2005-162586 discloses a hydrogen producer (FIG. 9) in which contact between the carrier 202 and the hydrogen-selective membrane is prevented because a carrier 202 for carrying a steam reforming catalyst is integrally coupled with a tube wall 203 of a reaction tube 112 for producing hydrogen, thereby improving the durability of a hydrogen-selective membrane. In this hydrogen producer, raw gas exchanges heat with hydrogen introduced through the hydrogen-selective membrane.

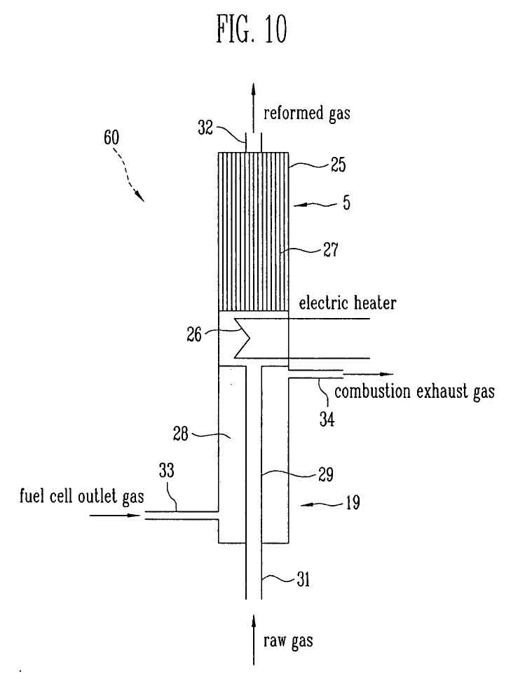

Also, Japanese Patent Application Publication No. 2001-106513 discloses a fuel reforming apparatus (FIG. 10) in which an electric preheater 26 is placed between a fuel reformer 5 and a combustor 19. The combustor 19 has a double-tube structure including a container 25 as an outer tube and a raw-gas passage 29 as an inner tube. In this fuel reforming apparatus, the fuel gas passage 29 and the fuel reformer 5 are provided as separate members.

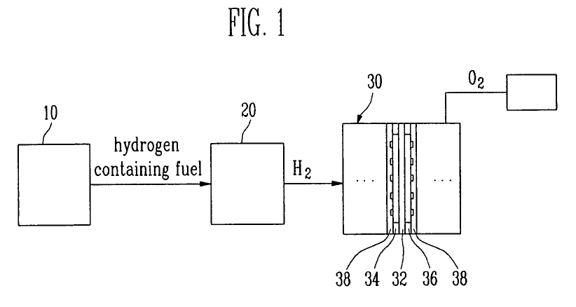

Referring to FIG. 1, a fuel cell system according to one embodiment includes a fuel feeder 10 to store a hydrogen-containing fuel to be reformed; a reformer 20 having a reforming reaction unit to produce hydrogen gas by reforming the hydrogen-containing fuel supplied from the fuel feeder 10; and an electric generator 30 to generate electricity through electrochemical reaction between the hydrogen gas from the reformer 20 and an oxidant. In this embodiment, an oxidant supplied to the electric generator 30 includes pure oxygen gas or oxygen-containing air stored in a separate storage. The oxidant may be supplied by an air feeder to the electric generator 30.

A portion of the hydrogen-containing fuel stored in the fuel feeder may be supplied as a reforming fuel into the reforming reaction unit of the reformer 20. The remaining portion of the fuel may be supplied as a combustion fuel into a heat source (not shown) for heating the reformer 20.

The reformer 20 includes the reforming reaction unit to shift the hydrogen-containing fuel into a reformed gas mainly containing hydrogen. The reformer 20 may also include a carbon monoxide remover to remove carbon monoxide from the reformed gas discharged from the reforming reaction unit.

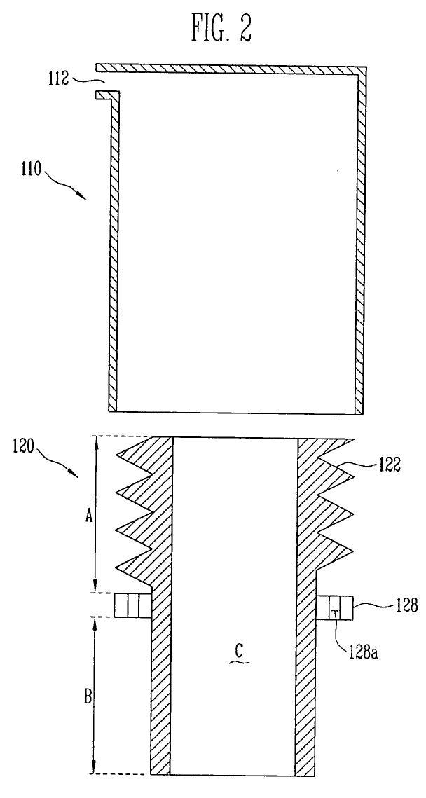

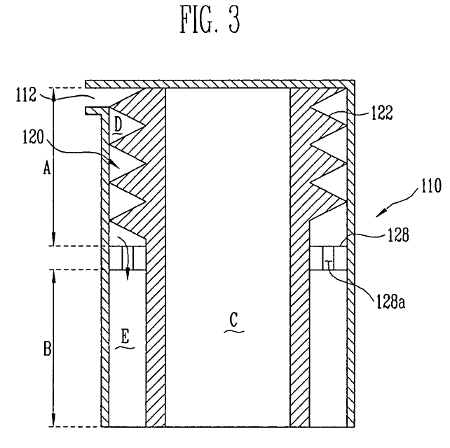

According to one embodiment, as shown in FIGS. 2 and 3, the reforming reaction unit includes a cylindrical structure 120, a cover 110, and a disc plate 128. The cylindrical structure 120 has a hollow space C inside thereof. The cover 110 surrounds the outer surface of the cylindrical structure 120. The disc plate 128 is ring-shaped and is interposed between the cylindrical structure 120 and the cover 110. The disc plate 128 surrounds the cylindrical structure 120 at a predetermined position thereof in a lengthwise direction. The disc plate 129 has a plurality of holes 128a extending along the cylindrical structure 120. The disc plate 128 contacts the inner surface of the cover 110 and the outer surface of the cylindrical structure 120.

The hollow space C of the cylindrical structure 120 provides a space through which heat energy generated by combustion reaction in a combustor (to be described later) is transferred. In the illustrated embodiment, the heat energy is generated by the combustor, but not limited thereto. Alternatively, the heat energy may be generated by any other suitable means. For example, the heat energy may be provided by an external heat source.

The illustrated disc plate 128 is formed around the cylindrical structure 120 midway in the lengthwise direction. In one embodiment, the disc plate 128 and the cylindrical structure 120 may be formed integrally with each other. In another embodiment, they can be formed separately and then assembled with each other. In the illustrated embodiment, the disc plate 128 has a circular shape, but not limited thereto. Alternatively, the disc plate may have various other shapes, e.g., a rectangular shape.

The cylindrical structure 120 includes an upper part A above the disc plate 128, and a lower part B below the disc plate 128. The upper part A of the cylindrical structure 120 has a thread 122 on its outer surface. A crest of the thread 122 is in direct contact with an inner surface of the cover 110. In the upper part A of the cylindrical structure 120, the thread 122 provides a space D between the cover 110 and the cylindrical structure 120. The space D serves as a fuel channel through which the hydrogen-containing fuel flows.

The lower part B of the cylindrical structure 120 has an outer diameter smaller than the inner diameter of the upper part A. In the lower part B of the cylindrical structure 120, a space E formed between the cover 110 and the cylindrical structure 120 is filled with a reforming catalyst (not shown). The space E serves as a reforming reaction space in which the hydrogen-containing fuel is shifted into the reformed gas that mainly contains hydrogen gas.

In the cylindrical structure 120, the upper part A and the lower part B are communicating with each other through the holes 128a formed in the disc plate 128. In other words, the holes 128a allow the space D serving as a fuel channel to be in fluid communication with the space E serving as a reforming reaction space. Accordingly, a hydrogen-containing fuel that flows through the fuel channel can move into the reforming reaction space through the holes 128a of the disc plate 128.

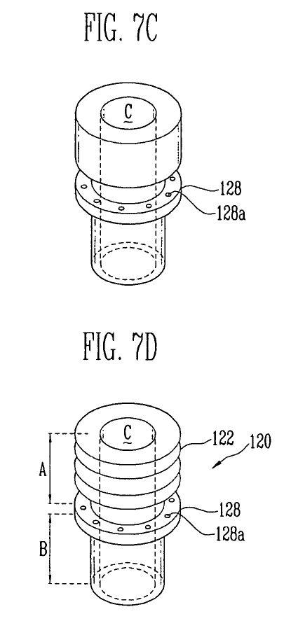

A process of manufacturing the cylindrical structure 120 will be described with reference to FIG. 7. First, a cylindrical body is provided (FIG. 7A). A hole is bored through the cylindrical body, using a drill or the like (FIG. 7B). The hole serves as the hollow space C of the cylindrical structure 120 described above. The disc plate 128 may be formed by cutting a lower part of the cylindrical body. A plurality of holes 128a are bored through the disc plate 128 (FIG. 7C). The thread 122 may be formed by threading the upper outer surface of the cylindrical body (FIG. 7D). Alternatively, the lower part of the cylindrical body may be processed earlier than the upper part.

In the illustrated embodiment, the disc plate 128 is integrally formed with the lower part of the cylindrical body by cutting, but not limited thereto. Alternatively, the disc plate may be provided separately and then coupled to the lower part of the cylindrical body.

The cover 110 includes a hollow cylindrical body having an open bottom. Further, an inlet 112 is provided at an upper part of the hollow cylindrical body so that the hydrogen-containing fuel is introduced through the inlet 112. The inlet 112 communicates with the fuel channel formed by the thread 122.

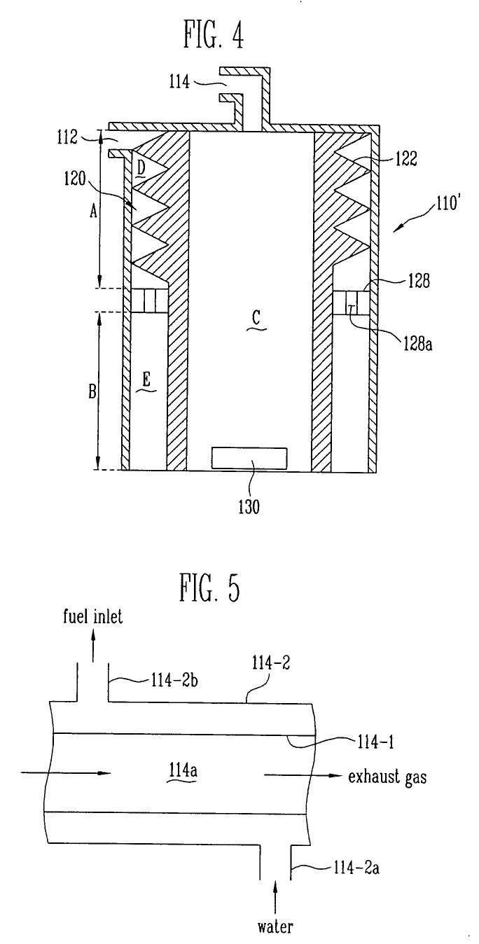

Further, a combustion unit 130 (FIG. 4) may be positioned at the bottom of the cylindrical structure 120 within the hollow space C. The combustion unit 130 is provided for supplying heat energy to the fuel channel and the reforming reaction space, which are formed between the cylindrical structure 120 and the cover 110.

According to one embodiment, a discharging tube 114 is provided on top of a cover 110′ such that exhaust gas can be discharged through the discharging tube 114. While the inlet 112 is positioned on a lateral side of the cover 114′ and communicates with the fuel channel formed by the thread 122, the discharging tube 114 is placed on top of the cover 110′ and discharges the exhaust gas therethrough.

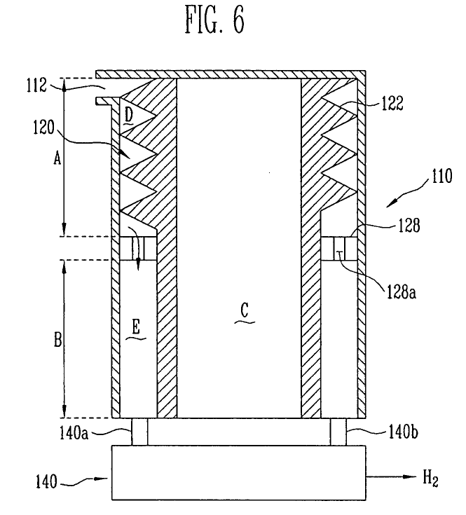

Referring to FIG. 5, the discharging tube 114 includes an internal tube 114-1 having a relatively small diameter, and an external tube 114-2 having a relatively large diameter. The internal tube 114-1 and the external tube 114-2 are coaxially arranged. In the illustrated embodiment, a space 114a within the internal tube 114-1 serves as an exhaust gas channel through which the exhaust gas flows in a direction denoted by the arrow. Further, a space formed between the internal tube 114-1 and the external tube 114-2 serves as a channel through which a fluid (e.g., water) flows. In the illustrated embodiment, water flows through the space while exchanging heat with the exhaust gas flowing through the internal tube 114-1. Thus, the temperature of the water can increase while the water flows through the space.

The external tube 114-2 includes a water inlet 114-2a through which water is introduced from a water feeder (not shown), and a water outlet 114-2b through which water passing the water channel is discharged. The water outlet 114-2b may communicate with the inlet 112 formed on a lateral side of the cover 110. Thus, water can be introduced through the inlet 112.

Referring to FIG. 4, the combustion unit 130 is provided on the bottom of the cylindrical structure 120 within the hollow space C. The combustion unit 130 can include a burner or combustion catalyst. A combustion fuel (e.g., a hydrogen-containing fuel) is supplied to the combustion unit 130. Heat energy generated by burning the combustion fuel in the combustion unit 130 is transferred to the fuel channel and the reforming reaction space through the cylindrical structure 120. Further, the exhaust gas produced while burning the combustion fuel is discharged to the outside through the discharging tube 114. In the illustrated embodiment, the exhaust gas discharged through the discharging tube 114 exchanges heat with water flowing through the water channel of the discharging tube 114.

According to one embodiment, heat energy is generated by combustion of the combustion unit 130, and is transferred to the fuel channel and the reforming reaction space via the cylindrical structure 120. While flowing through the fuel channel, the hydrogen-containing fuel introduced through the inlet 112 is preheated by the heat energy transferred via the cylindrical structure 120. The preheated hydrogen-containing fuel flows along the threads 122, and is introduced into the reforming reaction space E through the holes 128a of the disc plate 128. At this time, the hydrogen-containing fuel flows from an end of the thread 122 to the upper surface of the disc plate 128 in a direction parallel to the upper surface of the disc plate 128, so that the preheated hydrogen-containing fuel can be uniformly introduced into the reforming reaction space E through the holes 128a formed in the disc plate 128.

The hydrogen-containing fuel introduced into the reforming reaction space E is shifted into a reformed gas by the reforming reaction using the reforming catalyst. In the reforming reaction space E, the hydrogen-containing fuel is reformed by steam reforming (SR), partial oxidation (POX), auto-thermal reforming (ATR), or the like, but not limited thereto. Here, the partial oxidation (POX) and the auto-thermal reforming (ATR) are excellent in response characteristics depending on initial driving and load variation, while the steam reforming (SR) is excellent in efficiency of producing hydrogen.

The steam reforming (SR) produces a reformed gas that mainly contains hydrogen gas by a chemical reaction between the hydrogen-containing fuel and steam on a reforming catalyst. The steam reforming (SR) has been widely used because it stably supplies a reformed gas and produces hydrogen gas in a relatively high concentration. In one embodiment, hydrogen-containing fuel (i.e., reforming fuel) supplied from the fuel feeder 10 is shifted along with water supplied from the water feeder (not shown) into the reformed gas having abundant hydrogen on the reforming catalyst. The reforming catalyst may include a carrier supported with metal such as ruthenium, rhodium, nickel, etc. In other embodiments, the carrier may include zirconium dioxide, alumina, silica gel, active alumina, titanium dioxide, zeolite, active carbon, etc. Further, the reformed gas may include carbon dioxide, methane gas, carbon monoxide and the like in addition to hydrogen. Particularly, carbon monoxide deteriorates a platinum catalyst generally used for an electrode of an electric generator 30 (refer to FIG. 1) and adversely affects the performance of the fuel cell system. Therefore, there is a need to remove carbon monoxide.

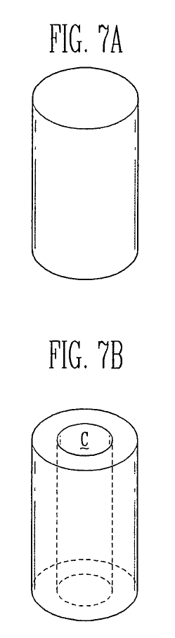

Referring to FIG. 6, to remove carbon monoxide from the reformed gas produced in the reforming reaction unit, a carbon monoxide remover 140 is positioned under the reforming reaction space. Further, the carbon monoxide remover 140 communicates with the reforming reaction space through a plurality of reformed gas outlets 140a and 140b.

The carbon monoxide remover 140 may include a water gas shift unit (not shown) and a partial oxidation unit (not shown) to perform a water gas shift reaction and a partial oxidation reaction, respectively. The water gas shift unit may include a shift catalyst (not shown). The partial oxidation unit may include an oxidation catalyst (not shown). Further, the partial oxidation unit may receive an oxidant needed for the partial oxidation reaction from the air feeder. The catalyst reaction removes carbon monoxide from the reformed gas introduced from the reforming reaction space into the carbon monoxide remover 140 through the reformed gas outlets 140a and 140b, thereby supplying hydrogen gas with high purity to the electric generator 30.

The electric generator 30 includes a plurality of unit cells. Each unit cell may include a membrane electrode assembly (MEA) having a polymer membrane 32 and electrodes 34 and 36 placed on the opposite sides of the polymer membrane 32; and separators 38 attached to the opposite sides of the membrane electrode assembly in order to supply hydrogen and oxygen. The separator 38 may include, but not limited to, a bipolar plate that is interposed between neighboring membrane electrode assemblies. The bipolar plate may have a first side formed with a hydrogen channel to supply hydrogen and a second side formed with an oxygen channel to supply oxygen.

When hydrogen gas of high purity is introduced from the carbon monoxide remover 140 of the reformer 20 to the electric generator 30, the hydrogen gas is supplied to the anode 34 of the membrane electrode assembly through the hydrogen channel of the separator 38. Further, when oxygen gas is introduced from the air feeder to the electric generator 30, the oxygen gas is supplied to the cathode 36 of the membrane electrode assembly through the oxygen channel of the separator 38. Accordingly, the hydrogen gas is oxidized in the anode 34, and the oxygen gas is reduced in the cathode 36, thereby generating electricity together with water as a byproduct.

According to one embodiment, the preheater for preheating the hydrogen-containing fuel to be reformed and the reforming reaction unit for reforming the hydrogen-containing fuel are manufactured as a single body, thereby enhancing the durability of the reformer.

Although a few embodiments have been shown and described, it would be appreciated by those skilled in the art that changes might be made in this embodiment without departing from the principles and spirit of the invention, the scope of which is defined in the claims and their equivalents.

What is claimed is:

1. A reformer for use with a fuel cell, comprising:
a first wall having an outer surface;
a second wall substantially surrounding the outer surface of the first wall, the first and second walls having a space therebetween; and
a partition interposed between the first and second walls, the partition dividing the space into a first space and a second space, the partition having at least one hole permitting fluid communication between the first and second spaces; and
an inlet in fluid communication with the first space,
wherein the first wall comprises a groove formed on the outer surface thereof in the first space, the groove and the second wall together defining a fluid pathway substantially surrounding the first wall, the fluid pathway leading from the inlet to the at least one hole of the partition.

2. The reformer of claim 1, wherein the first space serves as a preheater for a fuel.

3. The reformer of claim 1, wherein the second space serves as a reforming reactor.

4. The reformer of claim 1, further comprising a reforming catalyst in the second space.

5. The reformer of claim 1, wherein the inlet is formed through the second wall.

6. The reformer of claim 1, further comprising an outlet in fluid communication with the second space.

7. The reformer of claim 1, wherein the first wall having an inner surface, the inner surface defining a heat pathway.

8. The reformer of claim 1, further comprising a heat source positioned in the heat pathway.

9. The reformer of claim 8, wherein the heat source comprises a burner or a combustion catalyst.

10. The reformer of claim 8, further comprising a discharging tube, the discharging tube comprising an internal tube and an external tube substantially surrounding the internal tube with a gap therebetween, the internal tube being in fluid communication with the heat pathway, the gap being in fluid communication with the first space through the inlet.

11. The reformer of claim 1, wherein the first wall comprises a cylindrical tube.

12. The reformer of claim 1, wherein the first wall is formed of a substantially homogeneous material.

13. The reformer of claim 1, wherein the first wall is not formed by combining two or more workpieces.

14. The reformer of claim 12, wherein the first wall is formed by molding or machining.

15. The reformer of claim 1, wherein the groove forms a spiral thread.

16. The reformer of claim 15, wherein the spiral thread is formed by machining the outer surface of the first wall or by molding.

17. The reformer of claim 1, wherein the partition is formed by machining the outer surface of the first wall or by molding.

18. A method of making the reformer of claim 1, the method comprising:
providing the first wall;
providing the groove on the outer surface of the first wall; and
providing the partition on the outer surface of the first wall; and
providing the second wall so as to house the first wall.

19. The method of claim 18, wherein providing the first wall comprises forming a cylindrical tube by machining or by molding.

20. The method of claim 18, wherein providing the groove comprises machining the outer surface of the first wall or molding.

21. The method of claim 18, wherein providing the partition comprises machining the outer surface of the first wall or molding.

22. A method of using the reformer of claim 1, the method comprising:
introducing a fuel through the inlet into the first space;
flowing the fuel along the fluid pathway while providing heat along the heat pathway;
flowing the fuel through the at least one hole into the second space; and
subjecting the fuel to a reforming reaction in the second space.
